(19) United States
(12) Patent Application Publication
(10) Pub. No.: US 2023/0004583 A1
(43) Pub. Date: Jan. 5, 2023

(54) METHOD OF GRAPH MODELING ELECTRONIC DOCUMENTS WITH AUTHOR VERIFICATION

(71) Applicant: Copyright Clearance Center, Inc., Danvers, MA (US)

(72) Inventors: Haralambos Marmanis, Waltham, MA (US); Robin James Bramley, Worcestershire (GB); Matthew Kleiderman, Salem, MA (US)

(21) Appl. No.: 17/852,910

(22) Filed: Jun. 29, 2022

Related U.S. Application Data
(60) Provisional application No. 63/216,564, filed on Jun. 30, 2021.

(51) Int. Cl. G06F 16/28; G06F 16/22

(52) U.S. Cl. CPC G06F 16/287; G06F 16/2282

(57) ABSTRACT

A method for generating a graphical model of a plurality of electronic documents establishes connections between individual electronic documents with common authorship even if the spelling of the name of the author varies amongst the documents, for instance, due to the use of abbreviations, pseudonyms, misspellings, and the like. The graphical model is generated by ingesting data from the electronic documents and constructing a base graphical model using the processed data. Thereafter, as part of a disambiguation step, similar authors amongst the plurality of electronic documents are identified and clustered to yield an author similarity graph, which is preferably refined over time. A degree of belief, or similarity inference, is then calculated for documents determined to have common authorship and, in turn, incorporated into the base graphical model. As a result, an inference of the accuracy of linked information in the graphical model can be established.

### CROSS-REFERENCE TO RELATED APPLICATIONS

The present invention claims the benefit under 35 U.S.C. 119(e) to U.S. Provisional Patent Application No. 63/216,564, which was filed on Jun. 30, 2021, in the names of Haralambos Marmanis et al., the disclosure of which is incorporated herein by reference.

### FIELD OF THE INVENTION

The present invention relates generally to systems for compiling electronic documents and, more particularly, to systems for linking and integrating data amongst a plurality of electronic documents to produce a graph-structured data model, or knowledge graph, of the electronic documents.

### BACKGROUND OF THE INVENTION

Data is often modeled in order to, among other things, optimize searching, enhance analytics tools, and facilitate the integration of new content. For instance, graph data modeling, or graph modeling, is commonly applied to a collection of electronic documents to allow for the analysis and visualization of connections (i.e., relationships) between the various individual documents (i.e., nodes).

As an example, in FIG. 1, there is shown an illustrative graphical model of a collection of electronic articles, or documents, A₁thru A₉, the graphical model being represented generally by reference numeral 111. In graphical model 111, articles A₁ thru A₉, also shown as articles 113-1 thru 113-9, are depicted in terms of relatedness. Notably, a relatedness weight, or value, W is assigned to each vector in graphical model 111. In this capacity, a conditional dependence structure between articles 113-1 thru 113-9 can be utilized to, inter alia, understand the relatedness of articles.

A weighted graphical model (e.g., model 111) can be used to identify document clusters which, in turn, may represent distinct topics. For instance, in graphical model 111, articles 113-1 thru 113-5 together form a first document cluster, or sub-graph, 121-1 and articles 113-6 thru 113-9 form a second document cluster, or sub-graph, 121-2. Furthermore, semantic metadata relating to, inter alia, the confidence, or certainty, of the accuracy of information contained in the data model 111, can in turn be utilized to generate a knowledge graph.

As one useful application of graph modeling electronic documents (e.g., scientific articles), the identification of specific topics from the graphical model can be used to identify key opinion leaders for each topic based on the authorship of such documents. In other words, the author(s) associated with the most relevant articles within a particular cluster may be construed as a key leader with respect to that particular topic or field. The identification of key opinion leaders for a particular topic (e.g., covid-19 transmissibility) can be used to establish a collaboration network, wherein key leaders who are identified through the graphical model can serve as collaborators or peer reviewers in subsequent scientific articles on that specific topic.

Despite the usefulness set forth above, the applicant has recognized a notable shortcoming associated with the identification of key opinion leaders through the graph modeling of electronic documents. Notably, the applicant has recognized that certain inconsistencies in the spelling of the name of an author among different electronic documents often occurs due to, inter alia, (i) name misspellings, (ii) the use of abbreviations, and (iii) variances in the conversion of native language characters to Latin-based characters. Furthermore, although certain unique identification numbers/codes are often utilized to verify authorship (e.g., an ORCID identification number issued to academic authors and contributors by ORCID, Inc. of Bethesda, Md.), these types of identification codes are often (i) incorrectly entered or (ii) not assigned to certain individuals.

### SUMMARY OF THE INVENTION

In view thereof, it is an object of the present invention to provide a novel method for generating a graphical model of a plurality of electronic documents.

It is another object of the present invention to provide a method of the type as described above which establishes connections between individual electronic documents that contain related data.

It is yet another object of the present invention to provide a method of the type as described above which establishes connections between individual electronic documents with related document identifiers, such as authorship.

It is still another object of the present invention to provide a method of the type as described above which identifies potential spelling variances between identifiers associated with the various individual electronic documents.

It is yet still another object of the present invention to provide a method of the type as described above which determines the likelihood of relatedness between document identifiers with variances in spelling.

It is another object of the present invention to provide a method of the type as described above which incorporates connections in the graphical model between the document identifiers when determined to be related, or linked, despite variances in spelling.

It is yet another object of the present invention to provide a method of the type as described above which is inexpensive to implement, can be efficiently processed, and is readily scalable.

Accordingly, as one feature of the present invention, there is provided a computer-implemented method for generating a graphical model of a plurality of electronic documents, each electronic document comprised of data which includes identifying information, the identifying information including authorship, the method comprising the steps of (a) ingesting the data from each of the plurality of electronic documents, (b) constructing a base graphical model using the data from the plurality of electronic documents, (c) disambiguating any relatedness of identifying information between select pairs of the plurality of electronic documents, and (d) calculating a degree of belief of relatedness of identifying information between select pairs of electronic documents, wherein the degree of belief of relatedness of identifying information between select pairs of electronic documents is incorporated into the base graphical model.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings, wherein like reference numerals represent like parts:

FIG. 1 is an illustrative graphical model of a compilation of electronic documents;

FIG. 2 is a simplified flow chart depicting a novel method for generating a graphical model of information related to a plurality of electronic documents, the method being implemented according to the teachings of the present invention;

FIGS. 3(a)-(c) depict a series of flow charts which are useful in understanding how data is loaded as part of the data ingestion step shown in FIG. 2;

FIG. 4 is a flow chart which is useful in understanding how extracted article data is used to construct a base graph as part of the graph construction step shown in FIG. 2;

FIGS. 5(a)-(c) depict a series of flow charts which are useful in understanding the linking phase of the disambiguation step shown in FIG. 2;

FIGS. 6(a)-(c) depict a series of flow charts which are useful in understanding the clustering phase of the disambiguation step shown in FIG. 2;

FIG. 7 is a flow chart which is useful in understanding the classifier training phase of the disambiguation step shown in FIG. 2;

FIG. 8 is a flow chart which depicts an example of a cluster being refined as part of the disambiguation step shown in FIG. 2; and

FIG. 9 is a flow chart which is useful in understanding the inferencing calculation step shown in FIG. 2.

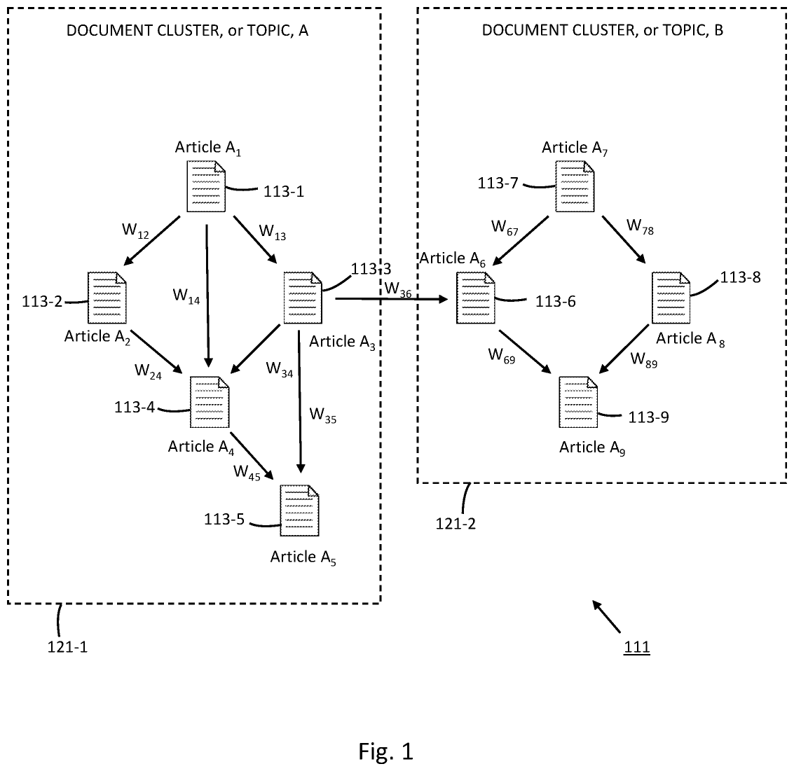

### DETAILED DESCRIPTION OF THE INVENTION

### Graph Modeling Method 211

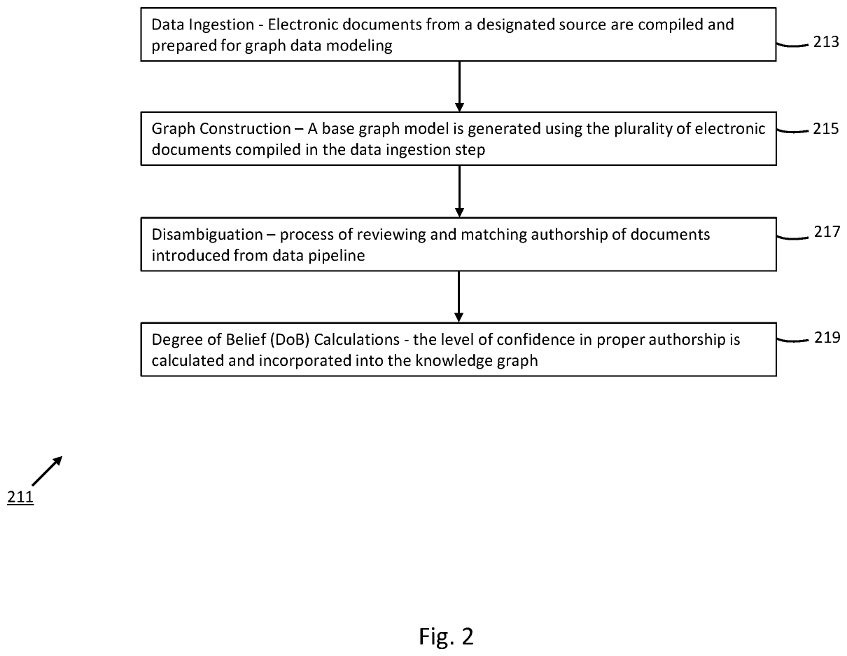

Referring now to FIG. 2, there is shown a flow chart depicting a novel method for generating a graphical model of information related to a plurality of electronic documents, the method being implemented according to the teachings of the present invention and identified generally by reference numeral 211. As will be explained in detail below, method 211 includes a series of novel steps, preferably automated primarily through the execution of application-specific computer software, which enables a degree of belief (DoB) relating to the accuracy of information in the graphical model to be incorporated into the model.

In the description that follows, method 211 is illustrated verifying the accuracy of the listed authorship for electronic documents in the graphical model. However, it should be noted that the principles of the present invention are not limited to incorporating information related to the certainty of authorship into a graphical model. Rather, it is to be understood that method 211 could be utilized to integrate a degree of belief, or confidence, of the veracity of any type of information, or data, included in the graphical model without departing from the spirit of the present invention.

As defined herein, the term “document” denotes any electronic record, or work. In the description that follows, documents are represented primarily as articles, such as scientific publications. However, it is to be understood that use of the term “document” herein is not intended to be limited to scientific publications or other similar types of articles. Rather, use of the term “document” is meant to encompass any/all forms of electronic records (e.g., arbitrary, text-based, information records) derived from any source, including literature, online news stories, and even database records, without departing from the spirit of the present invention.

As seen in FIG. 2, method 211 comprises (i) a data ingestion step 213 in which electronic documents are acquired, processed, and stored in a designated, cloud-based, data pipeline, (ii) a graph construction step 215 in which a base graph model is generated using, among other things, the plurality of electronic documents compiled in data ingestions step 213, (iii) a disambiguation step 217 in which the authorship of electronic documents in the base graph model is reviewed and selectively matched, and (iv) a belief calculation step 219 in which the level of confidence in the proper authorship of an electronic document is calculated and incorporated as additional information, or knowledge, into the graph model. The particulars associated with each of steps 213, 215, 217, and 219 are set forth in greater detail below.

### Data Ingestion Step 213

As referenced above, data ingestion step 213 involves acquiring, processing, and storing data from a set of electronic documents into a designated data pipeline. The frequency of data acquisition and ingestion is preferably dependent upon the volume and release dates of the electronic documents in the designated pipeline. As previously noted, the ingested data from the set of electronic documents is then subsequently utilized for data graph modeling.

Preferably, data ingestion step 213 is implemented entirely through a cloud computing services platform, thereby only requiring compute resources when processing data. For example, an Amazon Web Services (AWS) cloud computing services platform could be utilized to implement step 213, thereby allowing for an optimized selection and configuration of web services tools. For instance, data acquisition could be implemented using Python programming scripts on AWS-based Simple Storage Service (S3), processed using AWS-based Elastic MapReduce (EMR), and stored in a column-oriented file structure on the AWS-based Simple Storage Service (S3).

However, it should be noted that the use of a primarily AWS-based cloud computing services platform is provided for illustrative purposes only. Rather, step 213 could be similarly implemented using alternative cloud computing services platforms, such as the Microsoft Azure cloud computing services platform, without departing from the spirit of the present invention.

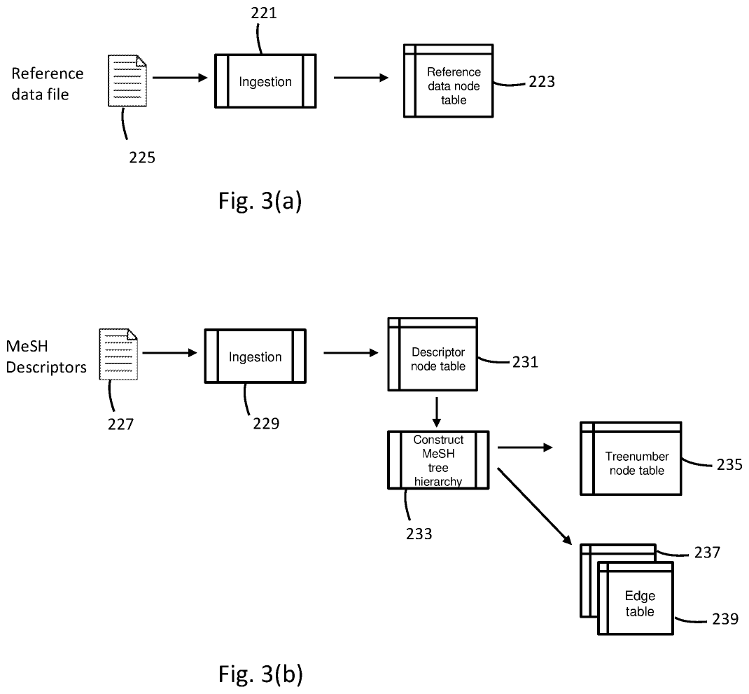

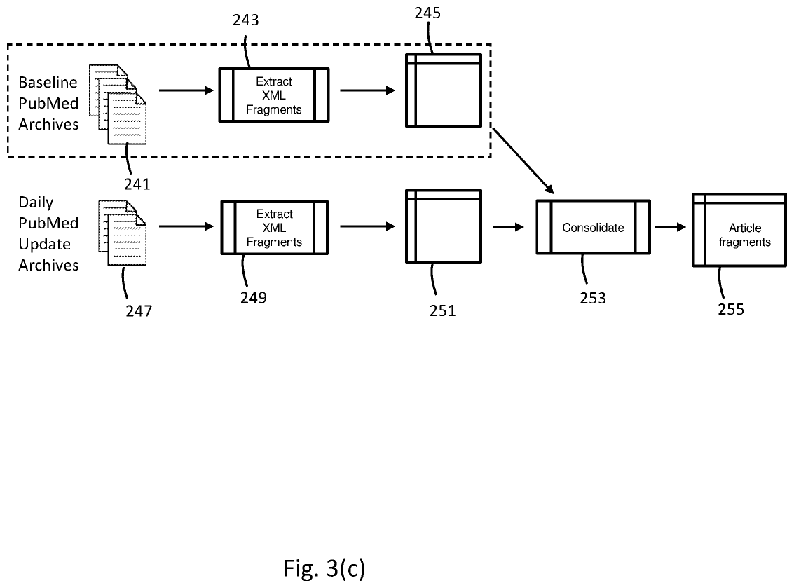

Referring now to FIGS. 3(a)-(c), a set of flow charts is shown which is useful in illustrating how data is loaded in data ingestion step 213. In the first stage of step 213, the nodes for the desired graph-structured data model, or graphical model, are created. Basic identifying, or reference, data associated with each node may represent, but are not limited to, institutions, journals, ontological/taxonomic terms, and where applicable, may contain hierarchical structures.

As seen in FIG. 3(a), an ingestion process 221 results in the loading of reference data tables 223 from reference data files 225 in the form of, inter alia, tabular file formats, structured text files, and XML files. Alternatively, reference data files 225 may be acquired from APIs, databases, or other sources including, but not restricted to, web mining.

As seen in FIG. 3(b), a reference data file 227 that contains hierarchical structures, for example taxonomies, requires additional steps in the ingestion process in order to reconstruct the hierarchy within the graphical model. For example, reference data file 227 is shown comprising Medical Subject Headings (MeSH) descriptors. Accordingly, ingestion process 229 creates and loads a descriptor node table 231 from reference data file 227. Thereafter, a tree construction process 233 creates both a treenumber node table 235 and two edge tables 237 and 239 from descriptor node table 231. Edge table 237 reflects the ‘broader than’/‘narrower than’ hierarchical relationship between terms in treenumber node table 235, and edge table 239 links the descriptor node table 231 to the treenumber node table 235 to allow for navigation within the graph.

In the second stage of step 213, article data (i.e., the content of each electronic document) is ingested into the data pipeline. As a novel feature of ingestion process 213, the present invention is designed to support any updates for article data ingested into the pipeline. For instance, FIG. 3(c) depicts an original set of article data files 241 (e.g., an annual data feed of scientific articles published via the PubMed database) from which XML fragments are extracted through an ingestion process 243 to create an article data table 245. However, the illustrative example shown in FIG. 3(c) also includes a daily set of update files 247 (e.g., to record deletions and/or revisions contained within the scientific articles). XML fragments are similarly extracted from update files 247 though an ingestion process 249 to create an updates data table 251.

Thereafter, through a consolidation process 253, data tables 245 and 251 are combined to create an intermediate data table 255 of article fragments, which represents the partially processed documents. Each record in table 255 preferably includes specifically extracted document properties, plus front and back matter fragments (e.g., the metadata and references). Where multiple overlapping sources are used for a single entity/node type, then a further consolidation/disambiguation step is required (not illustrated).

### Graph Construction Step 215

As referenced above, graph construction step 215 involves the creation of a base graph model using the data tables generated from data ingestions step 213, the model allowing for the visualization of relationships (shown as vectors) between various nodes (e.g., authors, article content, and general article reference data). Graph construction step 215 and disambiguation step 217 are preferably implemented using any suitable distributed data processing framework, such as Apache Spark. As such, graph data can be exported in a suitable format for a graph database management system such as Neo4j.

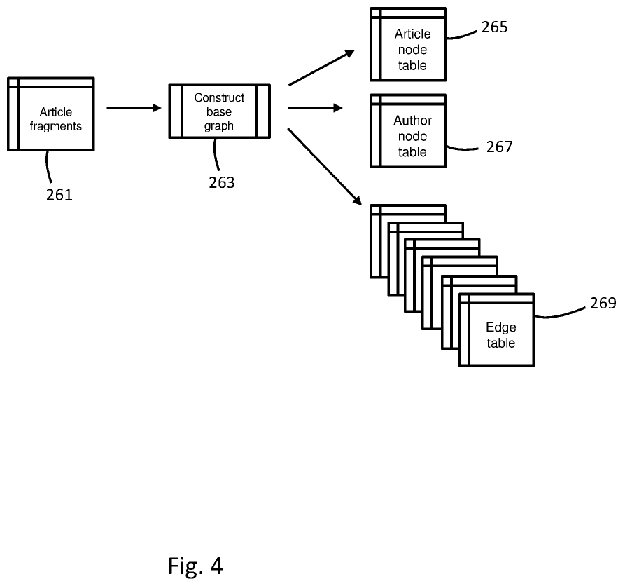

Referring now to FIG. 4, a flow chart is shown which is useful in illustrating how extracted article data is used to construct a base graph. Specifically, an intermediate data table 261 of article fragments is applied with an automated graph construction process 263 to construct (i) an article node table 265, which associates each electronic document in the data pipeline with a corresponding node in the graphical model, (ii) an author node table 267, which lists the author of each electronic document in the data pipeline, and (iii) graph edge tables 269, which represent certain relationships between nodes in the graphical model.

It should be noted that graph edge tables 269 may represent, inter alia, (i) relationships between different node types (e.g., contributions, or linking, between article nodes and author nodes), (ii) relationships between nodes of the same type (e.g., a citation reference, or linking, between multiple article nodes), and (iii) connections to reference data nodes (e.g., linking a scientific article with a particular journal in which it was published).

For optimal performance, edge construction preferably relies on well-known identifying information, or identifiers, whenever available. The use of well-known identifiers eliminates the need to perform a look-up of the target at write time. Depending on the quality of the input data source and/or implementor preferences or constraints, integrity checking may be required at construction time, prior to projection of the data, or delegated to a downstream graph database management system.

### Disambiguation Step 217

Author name disambiguation step 217 is a multi-stepped process which is designed to ensure, or verify, that the proper author is associated with each electronic document in the graphical model. As noted previously, the applicant has recognized that certain inconsistencies in the spelling of the name of an author amongst different document resources often results in the incorrect identification of an individual as a document author. As a result, the accuracy of a graph model generated for a collection of electronic documents can be significantly compromised. Accordingly, the process by which disambiguation step 217 serves to ensure, or certify, proper authorship is associated with a collection of scientific articles forms a critical aspect of the present invention.

Disambiguation step 217 is a split into the following sequence of phases: (i) a linking phase in which author node records are processed to identify similarities in author names and the analysis of paths occurring within a collaboration graph, (ii) a clustering phase in which a similarity graph is constructed using author nodes and similar person edges produced from the linking phase, and (iii) a refinement phase in which clustering results are examined to resolve author ambiguities created through the use of, inter alia, homonyms and synonyms. Each phase referenced above will be described further in detail below.

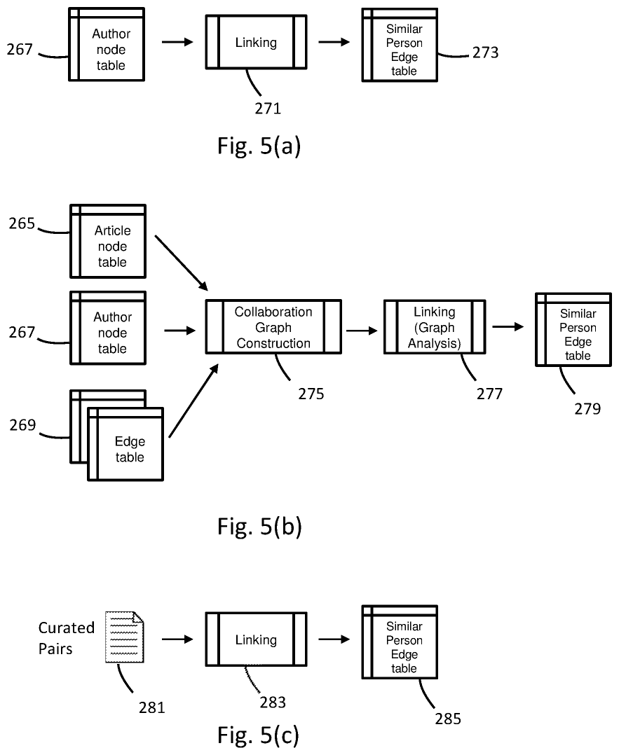

Referring now to FIGS. 5(a)-(c), a series of flow charts are shown which are useful in illustrating the linking phase of disambiguation step 217. As shown in FIG. 5(a), the data in author node table 267 created during graph construction step 215 is processed through a similarity linking process 271 to yield a similar person edge table 273. Process 271 for identifying and linking similar author nodes can be performed using at least one of following techniques: (i) name matching, in which a firstname, lastname hash algorithm is applied to the data in author node table 267, (ii) author identification code matching, in which unique identifiers assigned to authors (e.g., an ORCID identification number) are utilized to unambiguously link author nodes, and (iii) collaboration graph construction, in which a graph analysis is undertaken to identify common patterns of relationships between author nodes (i.e., authors), article nodes (i.e., articles), and reference edges (e.g., contributions, citations, and the like).

The collaboration graph construction technique is represented on the left-hand side of FIG. 5(b). As can be seen, the data from article node table 265, author node table 267, and edge tables 269 (the contribution and citation edge tables generated from graph construction step 215) is linked through a graph construction process 275 to yield a representation of the collaboration graph (not shown).

Self-citation is one example of a common pattern of relationships which can be identified through a graphing process. A self-citation occurs when an author cites another document previously written by the same author, which is common in the scientific community. Through self-citation graphing, two authors of articles can be linked by a citation. Through additional filtering and comparison of the author names, preferably using a last name and a first name initial, author synonyms can be discovered and, in turn, used to construct similarity edges between the citing author and the cited author. This is represented generally on the right-hand side of FIG. 5(b), where the collaboration graph produced by process 275 is analyzed in process 277 to produce a similar person edge table 279.

Fuzzy name matching is another example of a common pattern of relationships which can be improved through the application of a graphing process. Within the collaboration graph, communities, or cliques, within the graph model can be detected. Specifically in this case, linking phase 277 runs a connected components algorithm, which is an implementation of the alternating, big-star, little-star algorithm. Once the components have been allocated, the giant component is removed from consideration. Frequently, the remaining components have been found to be highly cohesive. Then, candidates (i.e., authors) are considered that are within the same component and share the same last name. If the initials and forename match exactly, the candidate is discarded since it should have already been identified through exact name (hash) matching. If candidates pass a high threshold, a name proximity similarity edge row is constructed in table 279. If candidates pass a lower threshold but the affiliation of the author passes a secondary threshold, an author name and affiliation proximity similarity edge row is constructed in table 279.

Fields of study matching is another example of a common pattern of relationships which can be identified through a graphing process. With fields of study matching, graphical paths are used to construct “fields of study” vectors that represent the specific topics on which an article author has been published. These fields of study vectors are then compared for candidate matches to reinforce similarity edges.

Finally, there is a mechanism to support certain known corrections in authorship. Specifically, as shown in FIG. 5(c), a data file of curated links 281 is constructed using a pair of article identifiers and author names. Processing data file 281 through a similarity linking process 283 yields a similar person edge table 285.

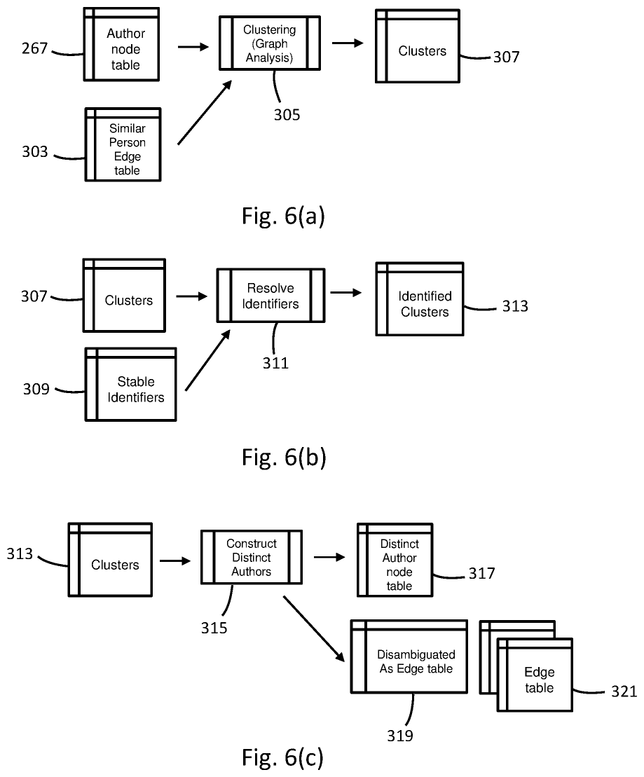

As referenced briefly above, upon completion of the linking phase of disambiguation step 217, a clustering phase is undertaken to construct a similarity graph using author nodes and similar person edges produced from the linking phase. Referring now to FIGS. 6(a)-(c), a series of flow charts are shown which are useful in illustrating the clustering phase of disambiguation step 217. As shown in FIG. 6(a), the data from an author node table 267 created during graph construction step 215 and the data from a similar person edge table 303 created during the linking phase (i.e., the union of tables 273, 279, and 285) is processed through a clustering graphical process 305 to yield a cluster table 307 in which author clusters are identified.

Preferably, an iterative graph algorithm is executed as part of process 305 to identify clusters of potentially common authors. Specifically, any graph clustering algorithm (such as a connected components algorithm) can be run to allocate clusters to each author node. The clusters are then processed and the name of the distinct author is selected on the basis of a general criterion of utility such as the longest name amongst all the names in the cluster or the most frequent occurrence of a name if all names are of approximately the same length.

It is important for downstream consumers of the data pipeline that distinct authors maintain stable identifiers (e.g., to allow for the augmentation of data). In other words, as articles within the data pipeline are added and/or removed, clusters in turn can grow (e.g., form new clusters), shrink (e.g., delete existing clusters), or remain the same. Accordingly, the members, or components, within each cluster may migrate between clusters, form a new cluster, or be permanently deleted.

Therefore, the clustering phase is preferably designed with logic to ensure that cluster identifiers remain stable. Referring now to FIG. 6(b), distinct author cluster identifiers in table 307 are compared against stable identifiers in a data table 309 from a previous cluster run as part of a cluster identifier resolution process 311 to yield an updated data table 313 of distinct author cluster identifiers.

Thereafter, the identified author clusters in table 313 are processed to produce distinct, or verified, author nodes. Specifically, a distinct author construction process 315 is applied to the clusters in table 313 to produce a distinct author node table 317. Subsequently, process 315 produces a disambiguated edge table 319 that links cluster members (i.e., author nodes defined in table 301) with the distinct author nodes defined in table 317, thereby facilitating in the reconciliation of authorship in the author nodes. Additionally, process 315 can be used to produce edge tables 321 which link the distinct author nodes defined in table 317 to other entities, such as articles, topics, collaborators, and the like.

As the final phase of disambiguation step 217, an optional refinement phase is undertaken in which clustering results are examined to resolve author ambiguities. Notably, due to the use of author homonyms and synonyms, clustering results can suffer from lumping and splitting errors. The identification of such errors can be accomplished using a classifier model trained on a labelled data set, as will be explained further below.

Specifically, as part of the refinement stage, a decision-tree classifier is trained using labelled data and, in turn, is utilized to refine author clusters. In other words, the decision-tree classifier is used to make predictions on whether cluster data (i.e., cluster members) represents the same person. Based on the pair-level predictions which can be interpreted as a distance measure, the cluster members can be re-clustered using a distributed clustering algorithm to produce refined clusters.

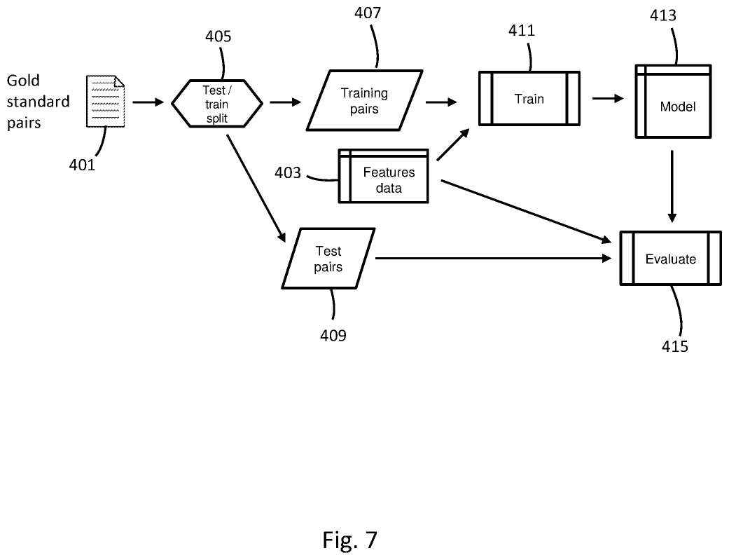

Referring now to FIG. 7, a flow chart is shown which is useful in illustrating the optional refinement phase of disambiguation step 217. As shown in FIG. 7, in the training portion of refinement stage, a classifier model is trained using ‘gold standard’ input data 401 and features data 403 which has been extracted from the graphical model that describes an article author.

Input data 401 is preferably labelled data that was intentionally withheld from the similarity, or cluster, model. Model training is computationally intensive in nature and involves (i) a preparation step 405, in which input data 401 is split into training pair data 407 and test pair data 409, (ii) a training process 411 in which features data 403 from the similarity model and training pair data 407 are used to create a trained classifier model 413, and (iii) a testing process 415 in which data from trained classifier model 413 and similarity model features table 403 is utilized to evaluate the clustering, or linking, of the ‘gold standard’ test pair data 409. If the results of evaluation process 415 exceeds the previous model, the refined similarity, or cluster, model is deployed.

The trained decision-tree classifier 413 is then utilised to predict pairwise whether members of the cluster refer to the same person. Pair predictions are then processed to split clusters when necessary.

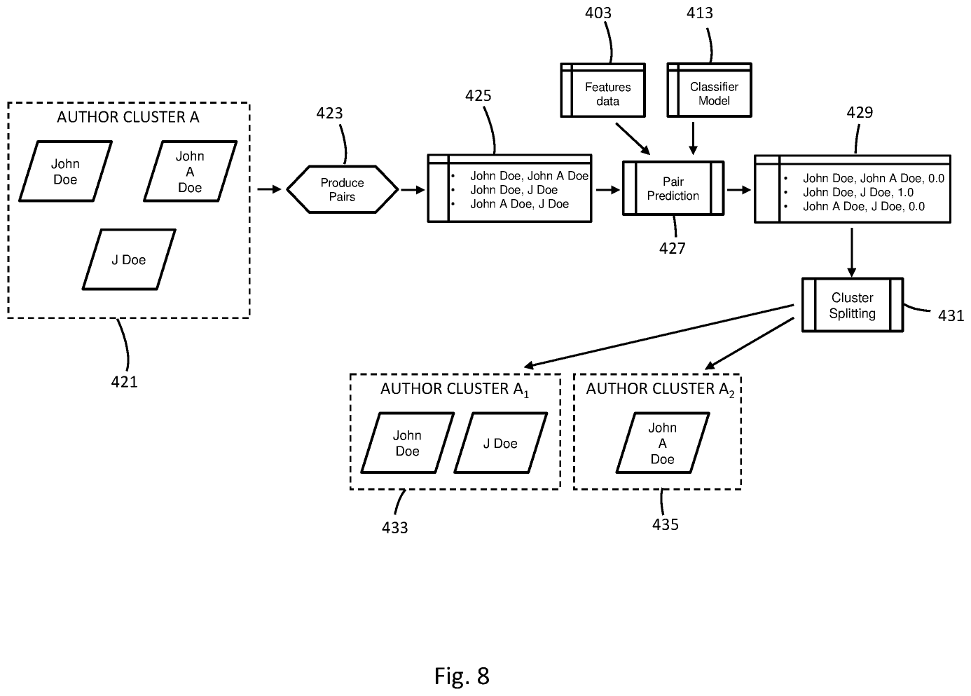

Referring now to FIG. 8, a sample author cluster 421 is shown which includes various author name data which has been preliminarily clustered together. As part of the inferencing process, cluster 421 is applied with a preparation step 423 to yield a data table of author pairs 425. Thereafter, a pair prediction algorithmic process 427 is applied to author pair data table 425 using features data table 403 and trained classifier model 413 to yield a pair prediction data table 429 in which an author similarity value is calculated and assigned to each author pair. As a part of an evaluation process 431, the results of pair prediction data table 429 are then utilized to refine the original member clusters. In the present example, original author cluster 421 is further subdivided into refined author clusters 433 and 435.

### Degree of Belief Calculation Step 219

As the final step of process 211, an inferencing, or degree of belief (DoB) calculation, step 219 is implemented in order to infer the level of confidence in matched, or linked, authors; though the application of the inferencing is not solely limited to authors and can be determined along multiple dimensions for other node or edge types within the knowledge graph. In turn, any author matching inferences are incorporated as additional information, or knowledge, into the graph model and can thereby ensure proper authorship of electronic document. Using belief calculation step 219, probabilities within the graphical model can be fed into inference algorithms to determine the likelihood of other relationships being true.

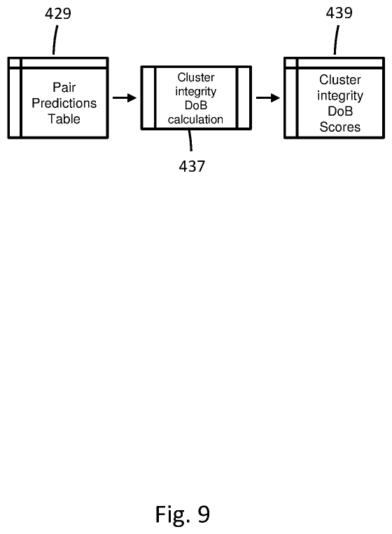

Referring now to FIG. 9, a flow chart is shown whereby the pair prediction data table 429 is utilized by a DoB calculation process 437 to derive a cluster integrity degree of belief score for each cluster 439. This is only an example, and for the purposes of the invention other knowledge graph data elements can be fed into specialized processes to compute other measures.

As an alternative example of calculating a degree of belief measure, the confidence in the volume of output created by an author may be calculated using the following formula:

(1−e^{-α(x-β)})/(1+e^{-α(x-β)})

where alpha (α) and beta (β) are controllable parameters. Two sensible values are α=β=2, and x is the logarithm of identified matches (or “duplicates”) minus some sensible upper limit of publications that an individual can produce within the specified time period. For values of x close to zero that function is approximately 1 whereas for larger values it drops rapidly (exponentially) to zero.

In terms of defining values, after processing metadata, all articles are identified in which a particular author is listed, either identically or according to an accepted set of variations for equivalence (e.g., Ralph Stephen Baric==R. S. Baric==Ralph A. Baric). These articles will span a time period of T years. Assuming an upper limit of articles published per year (PPYL), X is defined as:

X=Log(base 10)[Number of articles−PPYL*T]

PPYL is provided with a value of 50 to start and the results are examined. Because that value is high, only the truly most prolific authors would be able to match. Depending on the outcome, the value can be recalibrated, as needed, as well as the alpha and beta parameters of the DoB calculation equation.

The invention described in detail above is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A computer-implemented method for generating a graphical model of a plurality of electronic documents, each electronic document comprised of data which includes identifying information, the identifying information including authorship, the method comprising the steps of:
(a) ingesting the data from each of the plurality of electronic documents;
(b) constructing a base graphical model using the data from the plurality of electronic documents;
(c) disambiguating any relatedness of identifying information between select pairs of the plurality of electronic documents; and
(d) calculating a degree of belief of relatedness of identifying information between select pairs of electronic documents, wherein the degree of belief of relatedness of identifying information between select pairs of electronic documents is incorporated into the base graphical model.

2. The method as claimed in claim 1 wherein, as part of the disambiguating step, common authorship between select pairs of the plurality of electronic documents is identified.

3. The method as claimed in claim 2 wherein, as part of the disambiguating step, common authorship between select pairs of electronic documents is identified even with variances in spelling.

4. The method as claimed in claim 3 wherein, as part of the disambiguating step, pairs of electronic documents identified as having common authorship are linked.

5. The method as claimed in claim 4 wherein, as part of the calculating step, the degree of belief of common authorship between select pairs of electronic documents is assigned a numerical value of probability.

6. The method as claimed in claim 5 wherein, as part of the calculating step, the numerical value is calculated through a pair prediction algorithmic process.

7. The method as claimed in claim 6 wherein, as part of the ingesting step, data from the plurality of electronic documents is compiled and processed for data modeling.

8. The method as claimed in claim 7 wherein the ingesting step produces a table of data fragments from each of the plurality of electronic documents.

9. The method as claimed in claim 8 wherein, as part of the constructing step, the base graphical model is constructed using the table of data fragments from each of the plurality of electronic documents.

10. The method as claimed in claim 9 wherein, as part of the constructing step, the table of data fragments from each of the plurality of electronic documents is processed to yield a set of tables comprising:
(a) a document node table, which associates each electronic document with a corresponding node in the base graphical model;
(b) an author node table, which lists the authorship of each electronic document; and
(c) graph edge tables, which lists relationships between nodes in the base graphical model.

11. The method as claimed in claim 10 wherein the disambiguation step comprises:
(a) a linking phase in which the author node table is processed to identify similarities in author names and thereby allow for the construction of a collaboration graph, the collaboration graph comprising author nodes, article nodes, contribution edges and citation edges;
(b) a clustering phase in which a similarity graph is constructed using the author nodes and similar person edges, including those derived from the collaboration graph; and
(c) a refinement phase in which clustering results are examined to resolve variances in author names.

12. The method as claimed in claim 11 wherein the similar person edges are created using at least one technique from the group consisting of name matching, author identification code matching, and collaboration graph construction.
